(19) United States
(12) Patent Application Publication
(10) Pub. No.: US 2020/0317897 A1
(43) Pub. Date: Oct. 8, 2020

(54) High Density Thermoplastic Compounding Process and Material for Mining Applications

(71) Applicant: Bernard J. Kulkaski, Pine Grove, PA (US)

(72) Inventor: Bernard J. Kulkaski, Pine Grove, PA (US)

(21) Appl. No.: 16/839,414

(22) Filed: Apr. 3, 2020

Related U.S. Application Data
(60) Provisional application No. 62/830,383, filed on Apr. 6, 2019.

(51) Int. Cl. C08L 23/12; C08L 69/00; C08L 25/06; C08L 27/06; C08L 55/02

(52) U.S. Cl. CPC C08L 23/12; C08L 69/00; C08K 3/013; C08L 27/06; C08L 55/02; C08L 25/06

(57) ABSTRACT

A thermoplastic material created through a compounding process wherein the resulting material has a desired specific gravity to aid in separating lower specific gravity materials from those having a higher specific gravity. The present invention also pertains to a thermoplastic material or compound having properties that satisfy the performance requirements of mining operations and mine safety equipment. This material has an engineered density that causes it to sink during a purification process.

### CROSS REFERENCE TO RELATED APPLICATIONS

This application claims benefit of priority from U.S. Provisional Patent Application No. 62/830,383 of Bernard J. Kulkaski, filed on Apr. 6, 2019, titled HIGH DENSITY THERMOPLASTIC COMPOUNDING PROCESS AND MATERIAL FOR MINING APPLICATIONS, the entirety of which is incorporated herein by reference.

### STATEMENT REGARDING FEDERALLY SPONSORED RESEARCH/DEVELOPMENT

Not Applicable

### PARTIES TO A JOINT RESEARCH AGREEMENT

Not Applicable

### REFERENCE TO SEQUENCE LISTING, TABLE OR COMPUTER PROGRAM

Not Applicable

### FIELD OF THE INVENTION

The present invention pertains to a compounded thermoplastic material and process for creating such a material that can be used in mining operations and easily removed from mined material during a purification process. Compounding is a process of heat blending polymers with additives to modify the properties of the final material. In the present invention thermoplastics are melt blended with additives as well as a filler material to increase the specific gravity of the final composite material.

### BACKGROUND OF THE INVENTION

Raw mined material, such as coal, contains both naturally occurring and man-made impurities such as soil, sand, wood, rocks, minerals, mining hardware, and electrical components. These impurities must be removed in order to produce a more energy efficient and environmentally friendly material. Extraction of contaminants is typically accomplished through a variety of density separation techniques using air or fluid flotation methods. In this process, the raw mined material is washed in a fluid to remove the undesired material.

The washing process requires a fluid having a very particular specific gravity. In coal purification, for instance, the specific gravity of the liquid washing solution must range between 1.4 to 2.2 or higher depending on the level of purity that is desired. The particular specific gravity will depend on the materials being separated.

Washing the extracted rock or mineral within a solution having an appropriate specific gravity allows the mined material to float to the surface of the washing fluid while impurities and contaminants sink and settle to the bottom of the washing vessel. The purified material is then removed through agitation, screw mechanisms, sifting, or similar separation means.

Thermoplastic and thermoset materials are commonly used in the mining industry to manufacture various components used in the extraction process. These materials often find their way into the raw mined matter. Because polymers have a low specific gravity, these contaminants fail to sink to the base of the washing vessel in a typical washing process and instead, float on the surface of the fluid along with the desired material. The polymers remaining in the separated rock or mineral must be removed by some other means, resulting in higher extraction costs and lower quality material.

Certain pieces of hardware that are used in mining operations are critical to the overall safety of the personnel that work in the mines. There are many regulatory requirements to which an operator must comply that contribute to safe practices. These requirements often demand the use of specific pieces of hardware or tools. These may include strapping or blocking devices, netting or shielding devices, data or power transmission devices, or indication and warning devices. The presence of these hardware components within the mining operation often makes it difficult or nearly impossible to keep them from contaminating the target mineral stream. The subsequent removal of these materials can be made easier and thus more economical if the items are manufactured from a material engineered to facilitate their extraction during a normal part of the cleaning process.

There is therefore a need in the art for a compounded polymer material and a process for creating such materials wherein said material possesses the requisite properties to withstand the rigors of typical mining applications while having a specific gravity that is high enough to facilitate easy separation during the purification process.

### BRIEF DESCRIPTION OF THE DRAWINGS

FIG. 1 is a formula for calculating the percentages of each thermoplastic, filler, and additive required to achieve a compounded thermoplastic material having the required material specific gravity.

FIG. 2 is a flowchart outlining the process for manufacturing the compounded thermoplastic material.

### BRIEF DESCRIPTION OF THE INVENTION

As previously noted, thermoplastic and thermoset materials are commonly used in the mining industry; however, these mining components are typically made from low density materials which often end up in the processed rock or mineral. Plastic components within bearing plates, for instance, may be dislodged during coal extraction. These plastics float on the surface of the washing fluid during the purification process along with the mined coal, making them difficult to remove.

In the present invention, a thermoplastic having a low specific gravity is combined with a synthetic or natural filler, such as a mineral, having a higher specific gravity. Additives are also used to enhance the bonding between the filler and thermoplastic and to improve the flow and properties of the final composite material. The resulting engineered compound acquires material properties that are optimized for a particular mining application and easily separate during the purification process.

These engineered composites can be injection molded, extruded or machined to create mining tools and accessories of varying shapes, sizes, hardness, strength, and toughness. Because each engineered thermoplastic has a higher specific gravity or density than that of the separation liquid, any composite that has found its way into the mined material will sink to the base of the washing vessel during the separation process. This allows the composite to be easily extracted from the mined rock or mineral via a variety of density separation techniques.

### DETAILED DESCRIPTION OF THE INVENTION

For the purpose of this application, the separation liquid, solution, or fluid used in density separation and purification techniques shall be referred to as “washing fluid”. The terms “compounded material,” “composite material,” “composite,” “engineered thermoplastic,” “thermoplastic composite”, “final material,” and “engineered compound” shall be used interchangeably to refer to the engineered thermoplastic materials of the present invention. The term “compound” generally refers to a pellet or powder that has been mixed using heat, pressure or a combination of both.

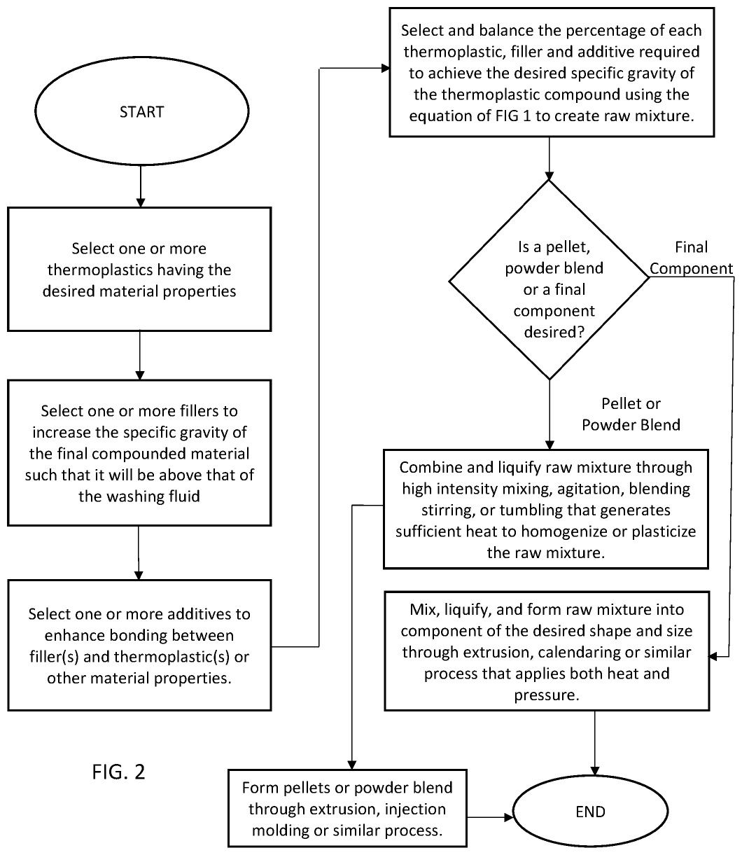

The present invention includes thermoplastic materials engineered specifically for use in the mining industry. A method for creating these composites is also outlined in FIG. 2. By engineering a composite material that has both an increased specific gravity and material properties that are enhanced for mining applications, the resulting high density composites will sink during the separation process, resulting in mined material of higher quality.

The composite materials are comprised of a combination of one or more thermoplastics, one or more fillers, and one or more additives. Any number of fillers may be combined with the preferred thermoplastic, provided that the required material properties and minimum specific gravity are achieved as discussed more fully below.

The specific gravity of the composite material (“SG_{CM}”) must lie above the specific gravity of the washing fluid. The specific gravity of the washing fluid may vary depending on the material being separated. In coal mining for instance, the specific gravity of the washing fluid is generally 1.4 to 2.3, therefore the specific gravity of the composite material used in a coal mining application must be greater than 1.4 to ensure that it sinks during the separation process. While any composite material having a specific gravity greater than or equal to 1.4 may be used for coal mining applications, it should be noted that achieving a specific gravity above 2.3 may not be economically feasible. With this in mind, the specific gravity of the composite material should ideally lie between 1.4 and 2.3 for coal mining applications.

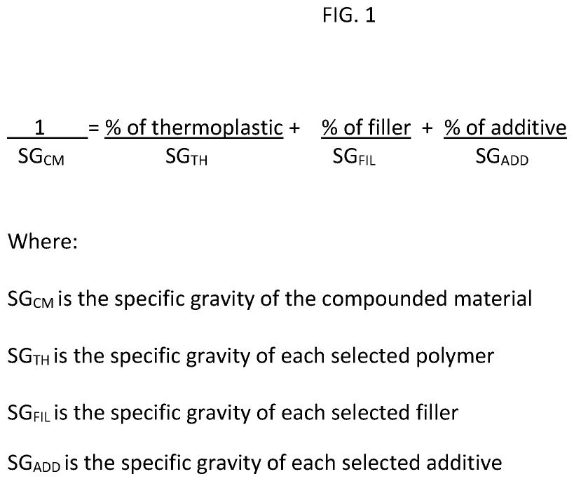

A material having the desired specific gravity is engineered by selecting and combining at least one thermoplastic, at least one filler, and at least one additive. The thermoplastic(s), filler(s), and additives(s) are selected and combined based upon their individual specific gravities as well as their strength, hardness, toughness, and ability to blend, bond, and flow. The specific gravity of each thermoplastic shall be referred to as SG_{TH}, the specific gravity of each filler shall be referred to as SG_{FIL} and the specific gravity of each additive shall be referred to as SG_{ADD}. Desired percentages of thermoplastic(s), filler(s), and additive(s) may be selected and balanced using the formula shown in FIG. 1.

The final material is engineered to perform under the conditions of a specific mining operation by selecting thermoplastics, fillers, and additives that provide the desired material properties as noted above. As a result, the percentage of thermoplastic(s), filler(s), and additive(s) used is highly dependent on the nature in which the final composite material will be used.

Thermoplastic(s) must comprise at least 30% by weight of the final material. Polyvinyl chloride (PVC) and acrylonitrile butadiene styrene (ABS) materials perform well due to their rigidity, toughness, and resistance to creep distortion; however, any suitable thermoplastic material may be used including but not limited to polypropylene, polystyrene and polycarbonate.

Any number of high density fillers may be combined with the preferred thermoplastic(s), provided that the required material properties are achieved and the specific gravity of the final material is greater than 1.4. The filler must comprise at least 30-70% by weight of the final material. Fillers may include but are not limited to calcium carbonate, glass, silica, barium sulfate, titanium dioxide, clay, talc, or metal elements. Additive(s) comprise the remaining portion of the composite material and may range from 0-20% by weight. Additives include but are not limited to compatibilizers, coupling agents, colorant, oils, lubricants, paraffins or other waxes, calcium, zinc stearate, flame retardant and smoke suppression materials.

Inventor contemplates the use of PVC OR ABS polymer in combination with a barium compound or talc. Talc and barium compounds have a high specific gravity and are relatively inert. Combining PVC with barium sulfate (BASO₄), and a compatibilizer for instance, results in a tough, rigid material with a high specific gravity that is resistant to creep. Inventor envisions one material having a range of 45-50% by weight of thermoplastic, 50%-53% by weight of BASO₄, and 2-5% by weight of the desired additives; however, it should be recognized that other ranges and materials may be used as noted above. A composition of 60% by weight of PVC, 40% by weight of BASO₄ and 0% additive would similarly provide a final compound having the required specific gravity and material properties.

The raw materials may be combined and formed into pellets that are later used to form a finished component having a specific gravity greater than that of the washing fluid. Alternatively, the raw materials may be combined and formed into the final component in a single manufacturing process. These alternative methods are described below and illustrated by the flowchart of FIG. 1:
i. Select at least 30% by weight of one or more thermoplastics based on specific gravity, desired material properties, and bonding characteristics;
ii. Select 30-60% by weight of one or more fillers based on specific gravity, desired material properties, and bonding characteristics;
iii. Selecting 0-20% by weight of one or more additives based on specific gravity, desired material properties, and bonding characteristics;
iv. Calculating the final percentage of material required for each thermoplastic, filler and additive based on the formula noted in FIG. 1 to create a raw thermoplastic compound mixture; and
v. If pellet or a powder blend are being produced for later manufacture of a final component: Homogenize or plasticize the raw thermoplastic compound mixture through high intensity stirring, tumbling, blending, agitation, or similar process that generates sufficient heat to create a molten mixture. Form the molten mixture into pellets through extrusion, injection molding or a similar forming process.
vi. If the final thermoplastic component is being produced in a single manufacturing operation: Combine and form the raw thermoplastic compound mixture into a final component of the desired shape and size through extrusion, calendaring, or a similar mixing and forming process.

The specification notes the use of thermoplastics; however, the specific gravities of thermoset materials, fiberglass compounds, and resin/catalyst epoxies may also be modified to sink in various separation techniques as described above. While the above description contains many specifics, these should be considered exemplifications of one or more embodiments rather than limitations on the scope of the invention. As previously discussed, many variations are possible and the scope of the invention should not be restricted by the examples illustrated herein.

1. A high density thermoplastic composite material having a specific gravity greater than that of the washing fluid used in a density separation process and comprising: a minimum of 30% by weight of one or more thermoplastics; between 30% and 70% by weight of one or more fillers; and between 0% and 20% by weight of one or more additives.

2. The material of claim 1, wherein said one or more thermoplastics is selected from polyvinyl chlorine, acrylonitrile butadiene styrene, polypropylene, polystyrene and polycarbonate; said one or more fillers is selected from calcium carbonate, glass, silica, barium sulfate, titanium dioxide, clay, talc, and metal elements; and said one or more additives is selected from compatibilizers, coupling agents, colorants, oils, lubricants, paraffins, waxes, calcium, zinc stearate, flame retardant, and smoke suppression materials.

3. The material of claim 1, having a specific gravity greater than 1.4.
A method for manufacturing a high density thermoplastic material, the method comprising:
Selecting and balancing at least 30% by weight of one or more thermoplastics, 30-60% by weight of one or more fillers, and 0-20% by weight of one or more additives based on specific gravity, desired material properties, and bonding characteristics to create a raw thermoplastic compound;
Homogenize or plasticize the raw thermoplastic compound through an operation that generates sufficient heat to create a mixed molten material; and
Forming the mixed molten material into thermoplastic composite pellets or powder blend having a specific gravity greater than that of a chosen washing fluid used in a density separation process.

4. The method of claim 3, wherein the specific gravity of the thermoplastic composite pellets or powder blend is greater than 1.4.

5. A method for manufacturing a high density thermoplastic composite component, the method comprising:
Selecting and balancing at least 30% by weight of one or more thermoplastics, 30-60% by weight of one or more fillers, and 0-20% by weight of one or more additives based on specific gravity, desired material properties, and bonding characteristics to create a raw thermoplastic compound; and
Mixing, heating, and forming the raw thermoplastic compound through an operation that generates sufficient heat and pressure to melt and form the raw thermoplastic compound into a final component of the desired shape and size having a specific gravity greater than that of a chosen washing fluid used in a density separation process.

6. The method of claim 5, wherein the specific gravity of the final component is greater than 1.4.
